(19) United States
(12) Patent Application Publication
(10) Pub. No.: US 2020/0073571 A1
(43) Pub. Date: Mar. 5, 2020

(54) MEMORY CONTROLLER AND ASSOCIATED ACCESSING METHOD

(71) Applicant: RayMX Microelectronics, Corp., Anhui Province (CN)

(72) Inventors: Yen-Chung CHEN, Zhubei City (TW); Han-Ting TSAI, Taipei City (TW); Wei-Ren HSU, Taipei City (TW); Wen-Hsin CHANG, Yuanlin City (TW)

(21) Appl. No.: 16/520,514

(22) Filed: Jul. 24, 2019

(30) Foreign Application Priority Data
Aug. 31, 2018 (TW) 107130648

(51) Int. Cl. G06F 3/06; G06N 5/04

(52) U.S. Cl. CPC G06F 3/0634; G06F 3/0605; G06N 5/04; G06F 3/0673; G06F 3/0659

(57) ABSTRACT

The present invention provides a memory controller including an artificial intelligence (AI) module and a microprocessor. In the operations of the memory controller, the AI module is arranged to determine a first user behavior model or a second user behavior model to generate a determination result according to a plurality of access commands and/or a plurality of parameters of a memory module controlled by the memory module. When the determination result indicates the first user behavior model, the microprocessor uses a first control strategy to control the memory module; and when the determination result indicates the second user behavior model, the microprocessor uses a second control strategy different from the first control strategy to control the memory module.

### BACKGROUND OF THE INVENTION

### 1. Field of the Invention

The present invention relates to a memory controller.

### 2. Description of the Prior Art

In a conventional memory controller (e.g. flash memory controller), control strategies for accessing a memory module are set by engineers based on pre-assumed user behaviors, and the parameters are set in the memory controller accordingly. For example, the memory controller always uses the same garbage collection trigger condition, the same wear-leveling operation and the same read scan operation trigger mechanism regardless of the situation. However, the behaviors of different users may have big differences, and the behaviors of the same user may change with time. Therefore, if the same control strategy is used to control the memory module, the system performance may not be optimized.

For example, homemakers or office workers may spend most of their time surfing the Internet or reading data, so the pursuit is the optimization of the read performance of the memory module; and the students may often download files or edit the files, to the pursuit is the write performance of the memory module. In addition to the considerations of the read performance and the write performance, different user behaviors are different for the damage of the memory module, so the preemptive and post-remediation of potential damage to different user behaviors is an important topic.

### SUMMARY OF THE INVENTION

It is therefore one of objectives of the present invention to provide a memory controller, which can refer to the user behavior to adopt different control strategies to control the memory module, to optimize the performance and/or life of the memory module, to solve the above-mentioned problems.

In a first embodiment of the present invention, a memory controller comprising an artificial intelligence (AI) module and a microprocessor is disclosed. In the operations of the memory controller, the AI module is arranged to determine a first user behavior model or a second user behavior model to generate a determination result according to a plurality of access commands and/or a plurality of parameters of a memory module controlled by the memory module. When the determination result indicates the first user behavior model, the microprocessor uses a first control strategy to control the memory module; and when the determination result indicates the second user behavior model, the microprocessor uses a second control strategy different from the first control strategy to control the memory module.

In a second embodiment of the present invention, a method for accessing a memory module is disclosed, wherein the method comprises the steps of: determining a first user behavior model or a second user behavior model to generate a determination result according to a plurality of access commands and/or a plurality of parameters of a memory module controlled by the memory module; when the determination result indicates the first user behavior model, using a first control strategy to control the memory module; and when the determination result indicates the second user behavior model, using a second control strategy different from the first control strategy to control the memory module.

In a third embodiment of the present invention, an electronic device comprising a memory module and a memory controller is disclosed, where the memory controller comprising an artificial intelligence (AI) module and a microprocessor is disclosed. In the operations of the memory controller, the AI module is arranged to determine a first user behavior model or a second user behavior model to generate a determination result according to a plurality of access commands and/or a plurality of parameters of a memory module controlled by the memory module. When the determination result indicates the first user behavior model, the microprocessor uses a first control strategy to control the memory module; and when the determination result indicates the second user behavior model, the microprocessor uses a second control strategy different from the first control strategy to control the memory module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to one embodiment of the present invention.

FIG. 2 shows blocks within the memory module and pages within each block according to one embodiment of the present invention.

FIG. 3 is a flowchart of a method for accessing the memory module according to one embodiment of the present invention.

### DETAILED DESCRIPTION

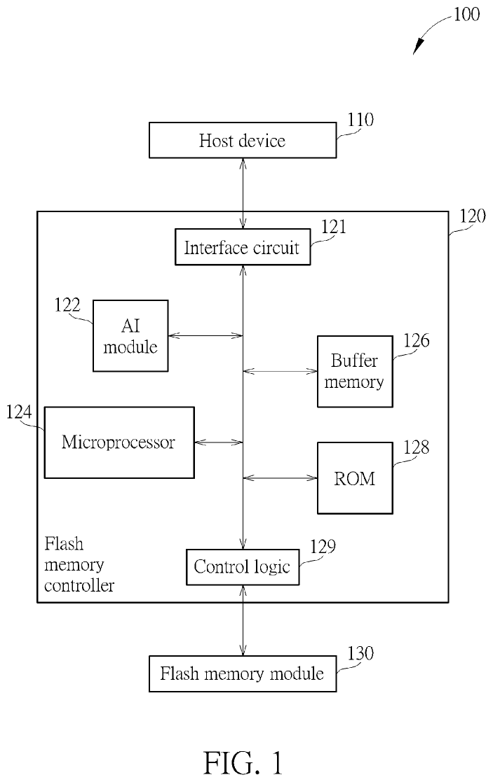

FIG. 1 is a diagram illustrating an electronic device 100 according to one embodiment of the present invention. As shown in FIG. 1, the electronic device 100 comprises a host device 110, a memory controller 120 and a memory module 130, where the memory controller 120 comprises an interface circuit 121, an AI module 122, a microprocessor 124, a buffer memory 126 (e.g. RAM), a read only memory (ROM) 128 and a control logic 129. The ROM 128 is used to store program codes, and the microprocessor 124 is configured to execute the program codes to control the access of the memory module 130, and the elements within the memory controller 120 may communicate with each other via a bus shown in FIG. 1. In this embodiment, the memory controller 120 and the memory module 130 can be regarded as a solid-state drive (SSD), the electronic device 100 can be any computer or server having the SSD, and the host device 110 can be a processor configured to access the memory module 130 via the memory controller 120. In an embodiment, the interface circuit 121 can be a Peripheral Component Interconnect Express (PCI-e) interface or an Advanced Technology Attachment (ATA) interface or Universal Serial Bus (USB) interface. The AI module 122 can also be called a Machine Learning module.

In one embodiment, the AI module 122 employs a Deep Learning algorithm. In one embodiment, the AI module 122 utilizes an artificial neural network (ANN) architecture to predict the next read command based on the current read command. In this embodiment, the decision logics are weighting values of the nodes in artificial neural network (ANN) architecture. In a preferred embodiment, the ANN architecture can be a Deep Convolutional Network (DCN) architecture or a Neural Turing Machine (NTM) architecture. In another embodiment, the AI module 122 includes an AI circuit and a memory unit (not shown in FIG. 1) for storing a predetermined AI algorithm and the AI circuit loads the predetermined AI algorithm to perform the deep learning.

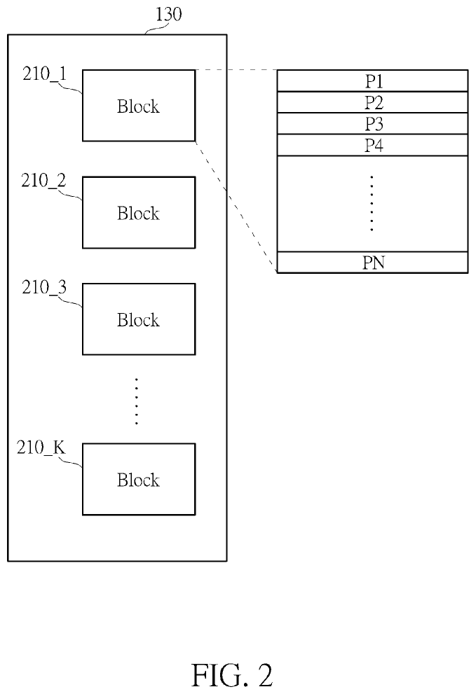

The memory module 130 comprises at least one memory chip, each memory chip comprises a plurality blocks, each block comprises a plurality of pages. In the designs of the memory, each block is a minimum erasing unit, that is all the data within the block must be erased together, and only deleting a portion of the data of the block is not allowed. In addition, each page is a minimum writing unit. Refer to FIG. 2, the memory module 130 comprises the blocks 210_1-210_K, and each of the blocks comprises a plurality of pages P1-PN.

In the operations of the electronic device 100, the AI module 122 is configured to determine a user behavior model of a user using the electronic device 100 to generate a determination result, and the microprocessor 124 refers to the determination result to determine one of the corresponding control strategies to control the memory module 130 to optimize the efficiency of the memory controller 120 and the memory module 130. For example, the AI module 122 may determine a first user behavior model or a second user behavior model of the user using the electronic device 100 to generate the determination result, wherein the first user behavior model indicates that the main behavior of the user operating the electronic device 100 is to read the memory module 130, and rarely write the data into the memory module 130. For example, the user spends most of the time reading data on the Internet or reading the file stored in the memory module 130, and rarely downloads a large amount of data from the network or uses the electronic device 100 to edit files for a long time. These users are similar to some homemakers or office workers who return home. In addition, the second user behavior model indicates that the user operates the electronic device 100 with certain skill. For example, the user may download a large amount of data from the network for a part of the time, or use the electronic device 100 to edit file for a long time. Such users are similar to some students or engineers.

In this embodiment, the AI module 122 can refer to a plurality of access commands from the host device 110 and/or a plurality of parameters of the memory module 130 to determine that the user's tendency to operate the electronic device 100 is a read operation (i.e., the first user behavior model described above) or a write operation (i.e., the second user behavior model described above), and the determination result is generated accordingly. In a first example, the AI module 122 generates the determination result according to an occurrence frequency of read commands and an occurrence frequency of write commands from the host device 110. Specifically, the AI module 122 can calculate how many write commands and how many read commands are sent to the memory controller 120 by the host device 110 over a period of time to calculate the occurrence frequency of the read commands and the occurrence frequency of the write commands. As another example, when the occurrence frequency of the write commands is lower than a threshold value and the occurrence frequency of the read commands is greater than another threshold value, the AI module 122 determines that the user's tendency is the read operations and determines the first user behavior model serving as the determination result. When the occurrence frequency of the write commands is greater than the threshold value, or when the occurrence frequency of the write commands is greater than the threshold value and the occurrence frequency of the read commands is lower than the other threshold value, the AI module 122 determines that the user's tendency is the write operations and determines the first user behavior model serving as the determination result.

In a second embodiment, the AI module 122 may generate the determination result according to a read count of the blocks 210_1-210_K of the memory module 130. Specifically, in the operations of the electronic device 100, the memory controller 120 continuously records and updates the read count of each of the blocks 210_1-210_K read by the memory controller 120, and the read counts of the blocks 210_1-210_K are temporarily stored in the buffer memory 126, then the read counts are moved to the memory module 130. It is noted that the above-mentioned read count starts to be generated and updated after the block is written by the memory controller 120, that is the read count of the block will return to zero if the block is erased. Therefore, the AI module 122 can determine if the user's tendency to operate the electronic device 100 is the read operations according to the read counts of at least a portion of the blocks 210_1-210_K. For example, if the read counts of at least a portion of the blocks 210_1-210_K are greater than a threshold value, or an average of the read counts of at least a portion of the blocks 210_1-210_K is greater than the threshold value, or any parameter capable of representing the read counts of at least a portion of the blocks 210_1-210_K is greater than the threshold value, the AI module 122 determines that the user's tendency to operate the electronic device 100 is the read operations, and the first user behavior model is determined accordingly to serve the determination result.

In a third embodiment, the AI module 122 may generate the determination result according to a generation time difference of the blocks 210_1-210-K of the memory module 130. Specifically, in the process of the memory controller 120 writing data into the memory module 130, if the memory controller 120 writes the data into a block and all the pages P1-PN within the block is about to be filled, the memory controller 120 will create the next block for continuously storing the data, where the difference between generation times of the current block and the next block is called the generation time difference. In light of above, if the host device 110 continuously sends the write commands to write the data into the memory module 130, the new blocks are created for storing the data frequently, and the generation time difference between two adjacent blocks of the blocks 210_1-210_K is short. In addition, if the host device 110 seldom sends the write commands to write the data into the memory module 130, the new blocks are created for storing the data infrequently, and the generation time difference between two adjacent blocks of the blocks 210_1-210_K is long. Therefore, if the blocks 210_1-210_K have the longer generation time difference (e.g., an average of the generation time differences within a period of time), the AI module 122 determines that the user's tendency to operate the electronic device 100 is the read operations, and the first user behavior model is determined accordingly to serve the determination result, and if the blocks 210_1-210_K have the shorter generation time difference, the AI module 122 determines that the user's tendency to operate the electronic device 100 is the write operations, and the second user behavior model is determined accordingly to serve the determination result.

In a fourth embodiment, the AI module 122 may generate the determination result according to a count (or frequency) of wear-leveling operations. Specifically, if the count or the frequency of the wear-leveling operations is higher, it means that the space within the memory module 130 may be insufficient or there is too much invalid data, that is the memory module 130 may be written frequently. Therefore, if the count or the frequency of the wear-leveling operations is greater than a threshold value, the AI module 122 determines that the user's tendency to operate the electronic device 100 is the write operations, and the second user behavior model is determined accordingly to serve the determination result; or if the count or the frequency of the wear-leveling operations is lower than a threshold value, the AI module 122 determines that the user's tendency to operate the electronic device 100 is the read operations, and the first user behavior model is determined accordingly to serve the determination result.

It is noted that the above four embodiments may be used in combination. That is, the AI module 122 may generate the determination result based on at least two of the following parameters: occurrence frequency of the read commands and the occurrence frequency of the write commands from the host device 110, read counts of the blocks 210_1-210_K, the generation time differences of the blocks 210_1-210_K, and the count or the frequency of the wear-leveling operations of the memory module 130. In addition, the above embodiments are for illustrative purposes only, the AI module 122 can refer to other parameters capable of representing that the user's tendency to generate the determination result.

Then, after the AI module 122 determines that the user's tendency is the read operations (i.e. the first user behavior model) or the user's tendency is the write operations (i.e. the second user behavior model), the microprocessor 124 can use the corresponding control strategy to control the memory module 130. Specifically, if the determination result indicates that the electronic device 100 has the first user behavior model, because the user's tendency is the read operations, the memory module 130 may have the data retention issue or data error because the data is not updated for a long time, and some areas of the memory module 130 may have the read disturbance issue. Therefore, the first control strategy used by the microprocessor 124 may include the read scan operation with the higher frequency to more actively read all the data pages P1-PN of certain blocks to determine whether the data quality meets the criteria; and when the data quality does not meet the criteria, the data in the block is moved to another block to ensure that the data that has not been updated for a long time will not be wrong. In addition, since the user behavior has fewer write operations, the first control strategy used by the microprocessor 124 may include less aggressive garbage collection operations (e.g. the garbage operation is triggered by a longer time or more invalid pages), or the first control strategy may include the less aggressive wear-leveling operations (e.g. the higher difference between the erase counts of the blocks is allowed). In addition, since the user having the first user behavior model usually has a long-term interruption of the use of the electronic device 100, the first control strategy used by the microprocessor 124 may include a more aggressive power saving mode. That is, the memory controller 120 and the memory module 130 can enter the power saving mode or the sleep mode more quickly.

If the determination result indicates that the electronic device 100 has the second user behavior model, because the user's tendency is the write operations, the memory module 130 does not suffer the data retention and read disturbance issues, so the second control strategy used by the microprocessor 124 may include read scan operations with lower frequency. In addition, since the user behavior has more write operations, the second control strategy used by the microprocessor 124 may include more aggressive garbage collection operations (e.g. the garbage operation is triggered by a shorter time or less invalid pages), or the second control strategy may include the more aggressive wear-leveling operations (e.g. the lower difference between the erase counts of the blocks is allowed). In addition, since the user having the second user behavior model does not usually has the long-term interruption of the use of the electronic device 100, the second control strategy used by the microprocessor 124 may include a less aggressive power saving mode.

In the above embodiments, only two user behavior models and only two control strategies are provided, however, these are not a limitation of the present invention. In other embodiments, the memory controller 120 may have other user behavior models such as the count/frequency of sudden power off recovery (SPOR), or average idle time of the memory controller 120 and memory module 130, and the microprocessor 124 can generate the corresponding control strategy to optimize the efficiency and life of the memory module 130.

In one embodiment, the AI module 122 determines a plurality of behavior models and corresponding control strategies according to a plurality of parameters. Among them, Table 1 is an implementation of different situations in which various parameters appear in different behavior modes; Table 2 shows an implementation of different corresponding control strategies used by the controller in different behavior modes determined by the AI module 122.

TABLE 1

| | Parameter | | | | | | | |
|---|---|---|---|---|---|---|---|---|
| | Number | Number | Ratio of | Logical | Interval of | Comparison | Comparison | |
| | of Read | of Write | N(R) | Block | Command | between | between | Number |
| | command | command | and | Address | (Host | Gen_time | N(W) of | of Wear |
| behavior model | N(R) | N(W) | N(W) | (LBA) | IDLE) | of Blocks | Blocks | leveling |
| Home use | many | little | >4 | Often the | Long | Average & | Average | little |
| (Life mode) | | | | same | | long | | |
| Company Use | Normal | Normal | 4> & | different | Normal | Uneven & | Uneven | Uneven |
| (Profession Mode) | | | >0, 2 | | | Normal | | |
| Video use | letter | very | 0.2> | Very | Short | Average & | Average | little |
| (Recoding Mode) | | much | | different | | long | | |
| Testing use | very | very | ≈1 | Very | Short | Average & | Average | little |
| (Performance Mode) | much | much | | different | | short | | |

It can be found from Table 1 that the AI module 122 can determine at least four behavior models according to read commands and write commands from the host. For example, the AI module 122 can obtain the logical block address (LBA) and the number (N(R), N(W)) of the read commands and write commands within a predetermined time interval according to the read commands and write commands; and can be distinguished: home use (Home mode), school/company use (profession mode), video use (record mode) and performance priority (performance mode). Of course, supplemented by other parameters, the judgment of the AI module 122 can be more accurate. Of course, the AI module 122 can use other parameters sufficient for identification to determine different behavior models.

TABLE 2

| | Strategy | | | | |
|---|---|---|---|---|---|
| | | | | | SLC/ |
| | | | Wear | Power | nSLC |
| Mode | IDLE GC | Read scan | Leveling | Saving | Mode |
| Life | Impair | Enhance | Enhance | Enhance | SLC |
| Mode | | | | | |
| Profession | Enhance | Impair | Enhance | Impair | Both |
| Mode | | | | | |
| Recoding | Impair | Impair | Impair | Impair | nSLC |
| Mode | | | | | |
| Performance | Impair | Impair | Impair | Impair | SLC |
| Mode | | | | | |
| storage | Impair | Enhance | Impair | Enhance | SLC |
| quality mode | | | | | |

It can be seen from Table 2 that after the AI module 122 determines different behavior models, the microprocessor 124 determines the corresponding control strategy according to the determined behavior model. The control strategy may include at least one of idle garbage collection (GC), read scan, Wear leveling, power saving, and using single level cell (SLC)/non-SLC (nSLC). The nSLC includes a multi-level cell (MLC), a triple level cell (TLC), or a quad-level cell (QLC).

In another embodiment, the AI module 122 can determine whether the power supply is stable according to a number of Sudden Power Off Recovery (SPOR), and determine to enter a storage quality mode in Table 2 according to the situation of stable power supply. In another embodiment, the AI module 122 can further analyze the possible time period of the power supply instability according to the number of the Sudden Power Off Recovery (SPOR) and a system time from the host, and then perform different control strategies according to different time periods. That is to say, the microprocessor 124 divides the time period into a power supply unstable period and a power supply stable period according to the analysis result provided by the AI module 122, and performs different control strategies (e.g. storage quality mode and profession mode) in the power supply unstable period and the power supply stable period.

In one embodiment, the AI module 122 is trained to determine a plurality of decision logics which is weighting values of the AI module 122 when the memory controller 120 is in an off-line state, and the AI module 122 uses the plurality of decision logics to determine the user behavior model to generate the determination result. For example, when the memory controller 120 is in the off-line state (i.e. the memory controller 120 does not connect to the memory module 130 yet), engineers can input the simulated access commands and the simulated parameters of the memory module 130 into the AI module 122 for the training operations to determine a portion of the decision logics, wherein the portion of the decision logics can be used to determine the user behavior model.

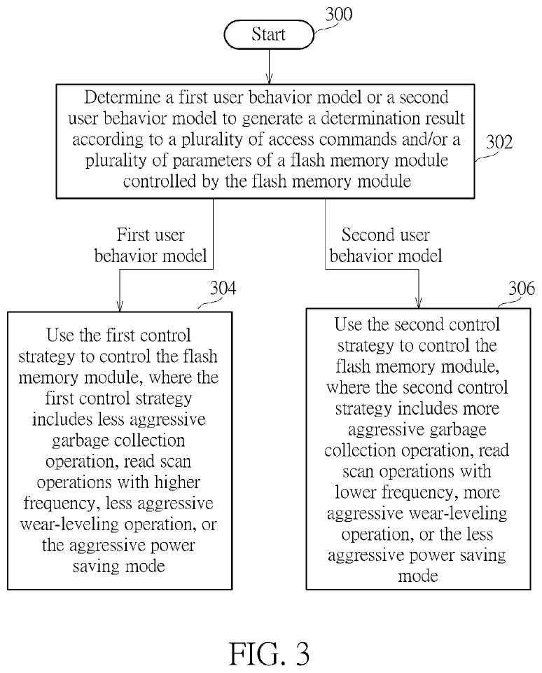

FIG. 3 is a flowchart of a method for accessing the memory module 130 according to one embodiment of the present invention. Refer to FIG. 1, FIG. 2 and the above disclosure, the flow is described as follows.

Step 300: the flow starts.

Step 302: determine a first user behavior model or a second user behavior model to generate a determination result according to a plurality of access commands and/or a plurality of parameters of a memory module controlled by the memory module. When the determination result is the first user behavior model, the flow enters Step 304; and when the determination result is the second user behavior model, the flow enters Step 306.

Step 304: use the first control strategy to control the memory module, where the first control strategy includes less aggressive garbage collection operation, read scan operations with higher frequency, less aggressive wear-leveling operation, or the aggressive power saving mode.

Step 306: use the second control strategy to control the memory module, where the second control strategy includes more aggressive garbage collection operation, read scan operations with lower frequency, more aggressive wear-leveling operation, or the less aggressive power saving mode.

Briefly summarized, in the memory controller of the present invention, the AI module is provided to determine the user behavior model of the electronic device, and the microprocessor selects the appropriate control strategy according to the user behavior model determined by the AI module, to optimize the efficiency and life of the memory module, and the preemptive and post-remediation of potential damage to different user behaviors can be achieved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A memory controller, comprising:
an artificial intelligence (AI) module, for determining a first user behavior model or a second user behavior model to generate a determination result according to a plurality of access commands and/or a plurality of parameters of a memory module controlled by the memory module;
a microprocessor, coupled to the AI module, wherein when the determination result indicates the first user behavior model, the microprocessor uses a first control strategy to control the memory module; and when the determination result indicates the second user behavior model, the microprocessor uses a second control strategy different from the first control strategy to control the memory module.

2. The memory controller of claim 1, wherein the AI module refers to an occurrence frequency of access commands from a host device to determine the first user behavior model or the second user behavior model to generate the determination result.

3. The memory controller of claim 2, wherein the occurrence frequency of the access commands comprise an occurrence frequency of read commands and an occurrence frequency of write commands, and the AI module at least refers to the occurrence frequency of the write commands to determine the first user behavior model or the second user behavior model to generate the determination result.

4. The memory controller of claim 3, wherein when the occurrence frequency of the write commands is lower than a threshold value and the occurrence frequency of the read commands is greater than another threshold value, the AI module determines the first user behavior model; and when the occurrence frequency of the write commands is greater than the threshold value, the AI module determines the second user behavior model.

5. The memory controller of claim 4, wherein when the determination result indicates the first user behavior model, the first control strategy used by the microprocessor comprises a less aggressive garbage collection operation, read scan operations with higher frequency, a less aggressive wear-leveling operation, or an aggressive power saving mode; and when the determination result indicates the second user behavior model, the second control strategy used by the microprocessor comprises the more aggressive garbage collection operation, the read scan operations with lower frequency, the more aggressive wear-leveling operation, or the less aggressive power saving mode.

6. The memory controller of claim 1, wherein the plurality of parameters comprise a read count of a plurality of blocks within the memory module, or a generation time difference of the blocks.

7. The memory controller of claim 6, wherein if the read count of the blocks of the memory module is greater than a threshold value, or if the generation time difference of the blocks of the memory module is greater than another threshold value, the first control strategy used by the microprocessor comprises a less aggressive garbage collection operation, read scan operations with higher frequency, a less aggressive wear-leveling operation, or an aggressive power saving mode; and if the read count of the blocks of the memory module is less than a threshold value, or if the generation time difference of the blocks of the memory module is less than the other threshold value, the second control strategy used by the microprocessor comprises the more aggressive garbage collection operation, the read scan operations with lower frequency, the more aggressive wear-leveling operation, or the less aggressive power saving mode.

8. The memory controller of claim 1, wherein the plurality of parameters comprise a count/frequency of wear-level operations of the flash memory module, a count/frequency of power off recoveries (POR), or an average idle time of the flash memory controller and the flash memory module.

9. A method for accessing a memory module, comprising:
determining a first user behavior model or a second user behavior model to generate a determination result according to a plurality of access commands and/or a plurality of parameters of the memory module;
when the determination result indicates the first user behavior model, using a first control strategy to control the memory module; and
when the determination result indicates the second user behavior model, using a second control strategy different from the first control strategy to control the memory module.

10. The method of claim 9, wherein the step of generating the determination result comprises:
referring to an occurrence frequency of access commands from a host device to determine the first user behavior model or the second user behavior model to generate the determination result.

11. The method of claim 10, wherein the occurrence frequency of the access commands comprise an occurrence frequency of read commands and an occurrence frequency of write commands, and the step of generating the determination result comprises:
at least referring to the occurrence frequency of the write commands to determine the first user behavior model or the second user behavior model to generate the determination result.

12. The method of claim 11, wherein the step of generating the determination result comprises:
when the occurrence frequency of the write commands is lower than a threshold value and the occurrence frequency of the read commands is greater than another threshold value, determining the first user behavior model to generate the determination result; and
when the occurrence frequency of the write commands is greater than the threshold value, determining the second user behavior model to generate the determination result.

13. The method of claim 12, wherein the first control strategy comprises a less aggressive garbage collection operation, read scan operations with higher frequency, a less aggressive wear-leveling operation, or an aggressive power saving mode; and the second control strategy comprises the more aggressive garbage collection operation, the read scan operations with lower frequency, the more aggressive wear-leveling operation, or the less aggressive power saving mode.

14. The method of claim 9, wherein the plurality of parameters comprise a read count of a plurality of blocks within the memory module, or a generation time difference of the blocks.

15. The method of claim 14, wherein the step of generating the determination result comprises:
if the read count of the blocks of the memory module is greater than a threshold value, or if the generation time difference of the blocks of the memory module is greater than another threshold value, determining the first user behavior model to generate the determination result; and
if the generation time difference of the blocks of the memory module is less than the other threshold value, or if the generation time difference of the blocks of the memory module is less than the other threshold value, determining the second user behavior model to generate the determination result;
wherein the first control strategy comprises a less aggressive garbage collection operation, read scan operations with higher frequency, a less aggressive wear-leveling operation, or an aggressive power saving mode; and the second control strategy comprises the more aggressive garbage collection operation, the read scan operations with lower frequency, the more aggressive wear-leveling operation, or the less aggressive power saving mode.

16. The method of claim 9, wherein the plurality of parameters comprise a count/frequency of wear-level operations of the memory module, a count/frequency of sudden power off recoveries (SPOR), or an average idle time of a memory controller.

17. An electronic device, comprising:
a memory module; and
a memory controller, for accessing the memory module, wherein the memory controller comprises:
an artificial intelligence (AI) module, for determining a first user behavior model or a second user behavior model to generate a determination result according to a plurality of access commands and/or a plurality of parameters of the memory module controlled by the memory module;
a microprocessor, coupled to the AI module, wherein when the determination result indicates the first user behavior model, the microprocessor uses a first control strategy to control the memory module; and when the determination result indicates the second user behavior model, the microprocessor uses a second control strategy different from the first control strategy to control the memory module.

18. The electronic device of claim 17, wherein the AI module refers to an occurrence frequency of access commands from a host device to determine the first user behavior model or the second user behavior model to generate the determination result.

19. The electronic device of claim 18, wherein the occurrence frequency of the access commands comprise an occurrence frequency of read commands and an occurrence frequency of write commands, and the AI module at least refers to the occurrence frequency of the write commands to determine the first user behavior model or the second user behavior model to generate the determination result.

20. The electronic device of claim 19, wherein when the occurrence frequency of the write commands is lower than a threshold value and the occurrence frequency of the read commands is greater than another threshold value, the AI module determines the first user behavior model; and when the occurrence frequency of the write commands is greater than the threshold value, the AI module determines the second user behavior model.
